(19) United States
(12) Patent Application Publication
(10) Pub. No.: US 2024/0013812 A1
(43) Pub. Date: Jan. 11, 2024

(54) METHOD AND APPARATUS FOR EXTRACTING HIGHLIGHT VIDEO

(71) Applicant: ELECTRONICS AND TELECOMMUNICATIONS RESEARCH INSTITUTE, Daejeon (KR)

(72) Inventors: Su-Young BAE, Daejeon (KR); Sang-Kwang LEE, Daejeon (KR); Seung-Jin HONG, Daejeon (KR)

(21) Appl. No.: 18/161,316

(22) Filed: Jan. 30, 2023

(30) Foreign Application Priority Data
Jul. 7, 2022 (KR) 10-2022-0083639

(51) Int. Cl. G11B 27/34; G11B 27/031

(52) U.S. Cl. CPC G11B 27/34; G11B 27/031

(57) ABSTRACT

Disclosed herein is a method for extracting a highlight video. The method may include receiving a video, detecting an event in the video using a learning model trained with resource images used for event detection, and extracting at least one highlight video based on the event.

### CROSS REFERENCE TO RELATED APPLICATION

This application claims the benefit of Korean Patent Application No. 10-2022-0083639, filed Jul. 7, 2022, which is hereby incorporated by reference in its entirety into this application.

### BACKGROUND OF THE INVENTION

### 1. Technical Field

The present disclosure relates generally to a highlight video extraction method and apparatus for automatically extracting a highlight video from a game.

### 2. Description of the Related Art

With an increase in the number of users enjoying games, various game leagues take place, and channels for streaming the game leagues and viewers are also increasing.

Viewers enjoy game plays in real time using mobile electronic devices and the Internet anywhere, anytime, but the demand for selecting only highlights in which views are interested after the game play is over and for repeatedly viewing and analyzing the highlights is increasing.

According to such demand, content producers separately extract highlight videos and provide the same.

Most game highlight videos that are currently provided are manually produced in such a way that a person checks game plays after the game is over. However, it takes a lot of time until a highlight video is uploaded, and due to limitations of cost and effort, it is difficult to apply this method to a large amount of game content acquired from various kinds of professional leagues and amateur competitions, and the like.

Also, existing game channels provide services mainly for some matches in which a large number of users are interested, so it is difficult to satisfy the needs of individual users.

### SUMMARY OF THE INVENTION

An object of the present disclosure is to provide a method and apparatus for extracting a highlight video in order to solve problems related to time and cost for extracting a highlight video.

Another object of the present disclosure is to provide a method and apparatus for extracting a highlight video in order to provide a highlight video that suits the needs of a user.

In order to accomplish the above objects, a method for extracting a highlight video according to the present disclosure may include receiving a video, detecting an event in the video using a learning model that is trained with resource images used for event detection, and extracting at least one highlight video based on the event.

The method may further include preprocessing the received video. The received video is divided into frames, whereby the received video may be preprocessed.

The method may further include analyzing whether the detected event is a single event or a complex event including multiple events.

Extracting the highlight video based on the event may include setting a highlight section based on the point at which the event occurs and generating the highlight video using a video of the highlight section.

Setting the highlight section based on the point at which the event occurs may include setting a point from which a highlight starts by analyzing a preceding part of the video based on the point at which the event occurs and setting the point at which the event occurs as a point at which the highlight ends, thereby setting the highlight section.

When the highlight video comprises multiple highlight videos, the highlight video to be provided to a user may be selected from among the multiple highlight videos based on a preference of the user and may then be provided.

The event may include at least one of a kill event between characters in the video, a death event therebetween, an assistance event therebetween, or an object destruction event in the video, or a combination thereof.

The video may include a real-time video or a previously stored video.

Also, an apparatus for extracting a highlight video according to an embodiment includes memory in which a control program for automatically extracting a highlight video is stored and a processor for executing the control program stored in the memory, and the processor may receive a video, detect an event in the video using a learning model that is trained with resource images used for event detection, and extract at least one highlight video based on the event.

The processor may preprocess the received video.

The processor divides the received video into frames, thereby preprocessing the received video.

The processor may analyze whether the detected event is a single event or a complex event including multiple events.

The processor may set a highlight section based on the point at which the event occurs and generate the highlight video using a video of the highlight section.

The processor may set a point from which a highlight starts by analyzing a preceding part of the video based on the point at which the event occurs, and may set the point at which the event occurs as a point at which the highlight ends, thereby setting the highlight section.

When the highlight video comprises multiple highlight videos, the processor may select the highlight video to be provided to a user from among the multiple highlight videos based on a preference of the user and provide the selected highlight video.

The event may include at least one of a kill event between characters in the video, a death event therebetween, an assistance event therebetween, or a main object destruction event in the video, or a combination thereof.

The video may include a real-time video or a previously stored video.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an apparatus for extracting a highlight video according to an embodiment of the present disclosure;

FIG. 2 is a block diagram illustrating the detailed configuration of an event detection unit according to an embodiment of the present disclosure;

FIG. 3 is a block diagram illustrating the detailed configuration of a highlight video extraction unit according to an embodiment of the present disclosure;

FIG. 4 is a flowchart illustrating a method for extracting a highlight video according to an embodiment of the present disclosure;

FIG. 5 is a flowchart illustrating a detailed process for detecting an event according to an embodiment of the present disclosure;

FIG. 6 is a flowchart illustrating a detailed process for extracting and managing a highlight video according to an embodiment of the present disclosure; and

FIG. 7 is a block diagram illustrating the configuration of a computer system according to an embodiment.

### DESCRIPTION OF THE PREFERRED EMBODIMENTS

The advantages and features of the present disclosure and methods of achieving the same will be apparent from the exemplary embodiments to be described below in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only, and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

In the present specification, each of expressions such as “A or B”, “at least one of A and B”, “at least one of A or B”, “at least one of A, B, and C”, and “at least one of A, B, or C” may include any one of the items listed in the expression or all possible combinations thereof.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

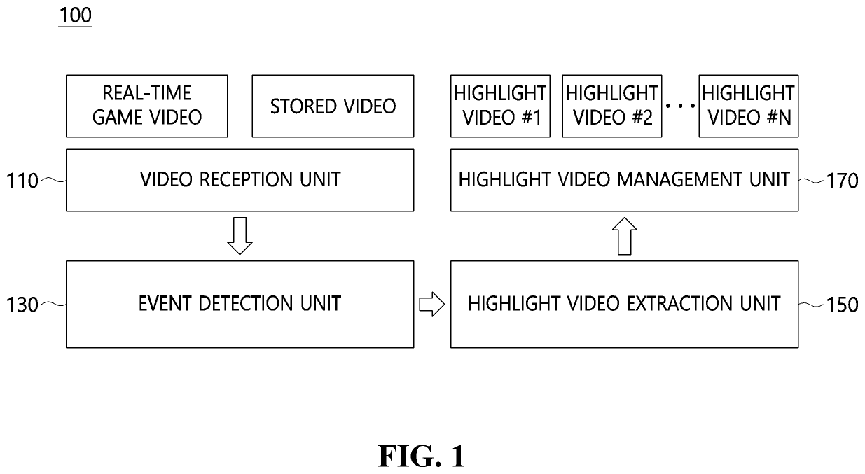

FIG. 1 is a block diagram illustrating an apparatus for extracting a highlight video according to an embodiment of the present disclosure.

Referring to FIG. 1, the apparatus 100 for extracting a highlight video may include a video reception unit 110, an event detection unit 130, a highlight video extraction unit 150, and a highlight video management unit 170.

The video reception unit 110 may receive a real-time game video or a previously stored game video.

The event detection unit 130 may detect an event in the received video using a pretrained learning model. Here, the event may include at least one of a kill event between characters in a game, a death event therebetween, an assistance event therebetween, or an object destruction event in the video, or a combination thereof.

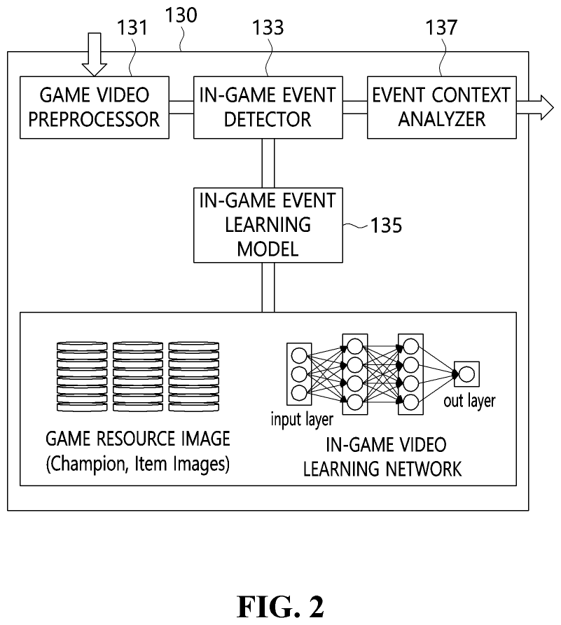

FIG. 2 is a block diagram illustrating the detailed configuration of an event detection unit according to an embodiment of the present disclosure.

As illustrated in FIG. 2, the event detection unit 130 may include a game video preprocessor 131, an in-game event detector 133, and an event context analyzer 137.

The game video preprocessor 131 may perform preprocessing on the received video. For example, the game video preprocessor 131 may perform preprocessing so as to divide the video into frames, each having duration of one second.

The in-game event detector 133 may detect an event using a learning model 135. The learning model 135 may be a model that is trained using game resource images, such as game characters, in-game event icons, and the like, which are used for event inference. The learning model may include a deep-learning model, but the types thereof are not limited.

The event context analyzer 137 may analyze whether a detected event is a single event or a complex event. Here, the complex event may be an event including multiple events. The event context analyzer 137 may analyze whether an event can be grouped with another event contextually so as to be classified as a complex event such as a team fight.

Referring back to FIG. 1, the highlight video extraction unit 150 may extract one or multiple highlight videos based on the event extracted by the event detection unit 130.

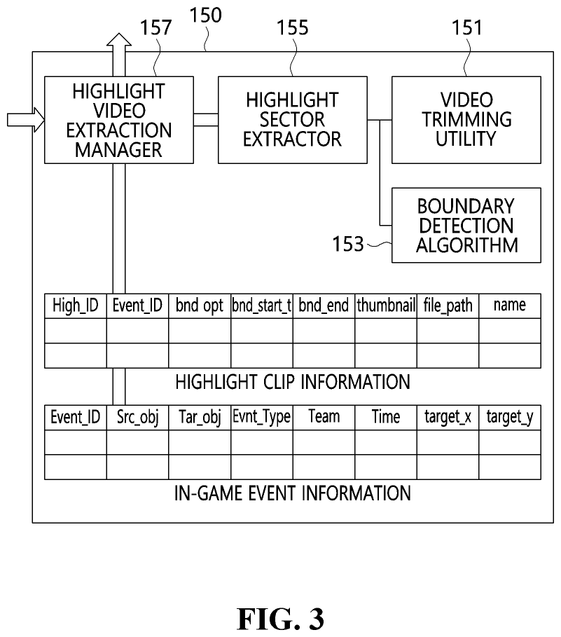

FIG. 3 is a block diagram illustrating the detailed configuration of a highlight video extraction unit according to an embodiment of the present disclosure.

As illustrated in FIG. 3, a boundary detection algorithm 153 may be used to set the point from which a highlight starts by analyzing image variation during a preset time period in the preceding part of the video by moving the video backwards from an event occurrence point, whereby the boundary of the highlight may be set. Here, the end point of the highlight may be set to the event occurrence point.

A highlight sector extractor 155 may set a sector based on the set highlight boundary points.

A highlight video extraction manager 157 may extract a highlight video by trimming the part set as the sector using a video trimming utility 151.

The highlight video extraction manager 157 may provide highlight clip information and in-game event information extracted from the highlight video.

Referring back to FIG. 1, the highlight video management unit 170 may manage multiple highlight videos. Also, the highlight video management unit 170 may select only a necessary highlight video based on user preferences and provide the same to a user.

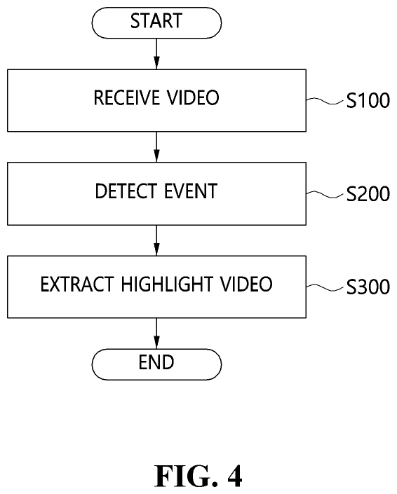

FIG. 4 is a flowchart illustrating a method for extracting a highlight video according to an embodiment of the present disclosure.

Referring to FIG. 4, the method for extracting a highlight video according to an embodiment of the present disclosure may include receiving a video, detecting an event, and extracting a highlight video. Here, the method for extracting a highlight video may be performed by an apparatus for extracting a highlight video.

The apparatus for extracting a highlight video may receive a real-time game video or a previously stored game video at step S100.

The apparatus for extracting a highlight video may detect an event in the video using a learning model that is trained with resource images used for event detection at step S200. The event may include at least one of a kill event between characters in a game, a death event therebetween, or an assistance event therebetween, or an object destruction event in the video, or a combination thereof.

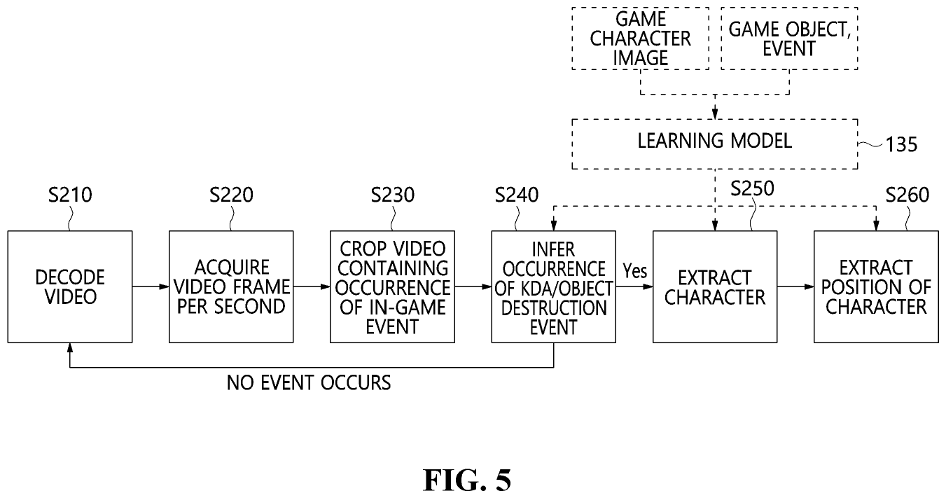

FIG. 5 is a flowchart illustrating a detailed process for detecting an event according to an embodiment of the present disclosure.

As illustrated in FIG. 5, the apparatus for extracting a highlight video may extract frames by decoding the received video at step S210. After a video frame having duration of one second is acquired from the decoded video at step S220, a section in which an event occurs is cropped at step S230, whereby whether a main event occurs in a game may be inferred.

The apparatus for extracting a highlight video may check whether Kill, Death, and Assistance (KDA) events between game characters and other events, such as a main object destruction event and the like, occur in the game at step S240. When no event occurs, the video is moved forwards in one second and is decoded again, and whether an event occurs may be checked.

When an event occurs, detailed information about characters involved in the event is extracted based on the inferred information at step S250, and the positions of the characters, and the like are extracted, whereby the event may be defined in detail at step S260.

Referring back to FIG. 4, the apparatus for extracting a highlight video may extract a highlight video based on the event at step S300.

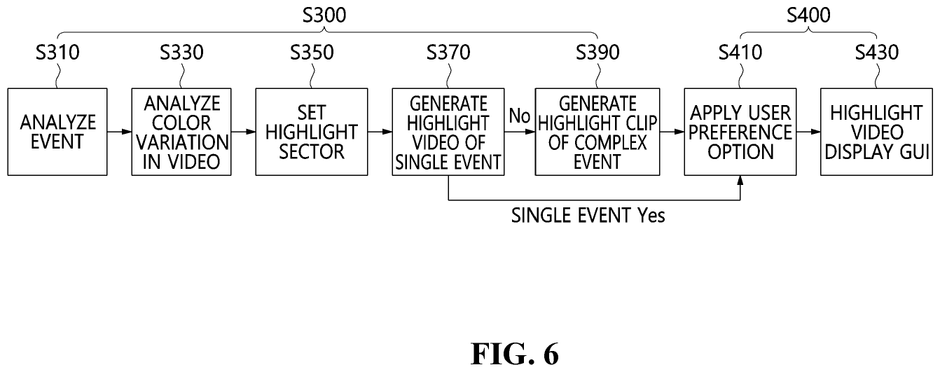

FIG. 6 is a flowchart illustrating a detailed process for extracting and managing a highlight video according to an embodiment of the present disclosure.

The apparatus for extracting a highlight video may analyze an event at step S310. The apparatus for extracting a highlight video regards the time at which the event occurs as the end point of a highlight video and analyzes color variation in the preceding part of the video before the endpoint, thereby finding the start point of the highlight event at step S330.

When the section of the highlight video is set, the apparatus for extracting a highlight video sets a highlight sector of the corresponding part at step S350, thereby generating a highlight video at step S370. Otherwise, when a highlight video includes a complex event, the sections in which associated events occur are clipped, whereby a highlight video may be generated once again at step S390.

When it is necessary to apply a user preference option, the apparatus for extracting a highlight video may use a highlight video selected in consideration of user preferences in order to form a highlight video list to show a user at step S410.

The apparatus for extracting a highlight video may provide the highlight video to the user through a user interface at step S430.

The apparatus for extracting a highlight video according to an embodiment may be implemented in a computer system including a computer-readable recording medium.

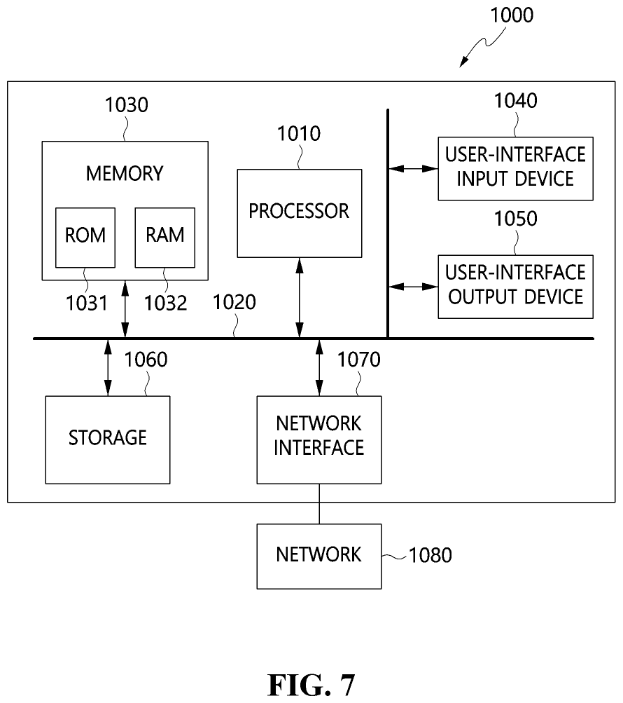

FIG. 7 is a block diagram illustrating the configuration of a computer system according to an embodiment.

Referring to FIG. 7, the computer system 1000 according to an embodiment may include one or more processors 1010, memory 1030, a user-interface input device 1040, a user-interface output device 1050, and storage 1060, which communicate with each other via a bus 1020. Also, the computer system 1000 may further include a network interface 1070 connected to a network.

The processor 1010 may be a central processing unit or a semiconductor device for executing a program or processing instructions stored in the memory or the storage. The processor 1010 is a kind of central processing unit, and may control the overall operation of the apparatus for extracting a highlight video.

The processor 1010 may include all kinds of devices capable of processing data. Here, the ‘processor’ may be, for example, a data-processing device embedded in hardware, which has a physically structured circuit in order to perform functions represented as code or instructions included in a program. Examples of the data-processing device embedded in hardware may include processing devices such as a microprocessor, a central processing unit (CPU), a processor core, a multiprocessor, an application-specific integrated circuit (ASIC), a field-programmable gate array (FPGA), and the like, but are not limited thereto.

The memory 1030 may store various kinds of data for overall operation, such as a control program, and the like, for performing a method for extracting a highlight video according to an embodiment. Specifically, the memory may store multiple applications running in the apparatus for extracting a highlight video and data and instructions for operation of the apparatus for extracting a highlight video.

The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to an embodiment, the computer-readable recording medium storing a computer program therein may contain instructions for making a processor perform a method including an operation for receiving a video, an operation for detecting an event in the video using a learning model that is trained with resource images used for event detection, and an operation for extracting at least one highlight video based on the event.

According to an embodiment, a computer program stored in the computer-readable recording medium may include instructions for making a processor perform an operation for receiving a video, an operation for detecting an event in the video using a learning model that is trained with resource images used for event detection, and an operation for extracting at least one highlight video based on the event.

According to the present disclosure, time and cost for extracting a highlight video may be reduced by automatically detecting the occurrence of main events in a game play video.

Also, the present disclosure provides a highlight video in consideration of game characteristics and user preferences, thereby satisfying the needs of a user.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for automatically extracting a highlight video, comprising:
receiving a video;
detecting an event in the video using a learning model that is trained with resource images used for event detection; and
extracting at least one highlight video based on the event.

2. The method of claim 1, further comprising:
preprocessing the received video.

3. The method of claim 2, wherein the received video is divided into frames, whereby the received video is preprocessed.

4. The method of claim 1, further comprising:
analyzing whether the detected event is a single event or a complex event including multiple events.

5. The method of claim 1, wherein extracting the highlight video based on the event includes
setting a highlight section based on a point at which the event occurs, and
generating the highlight video using a video of the highlight section.

6. The method of claim 5, wherein setting the highlight section based on the point at which the event occurs includes
setting a point from which a highlight starts by analyzing a preceding part of the video based on the point at which the event occurs, and
setting the point at which the event occurs as a point at which the highlight ends, thereby setting the highlight section.

7. The method of claim 1, wherein, when the highlight video comprises multiple highlight videos, the highlight video to be provided to a user is selected from among the multiple highlight videos based on a preference of the user and is then provided.

8. The method of claim 1, wherein the event includes at least one of a kill event between characters in the video, a death event therebetween, an assistance event therebetween, or an object destruction event in the video, or a combination thereof.

9. The method of claim 1, wherein the video includes a real-time video or a previously stored video.

10. An apparatus for automatically extracting a highlight video, comprising:
memory in which a control program for automatically extracting a highlight video is stored; and
a processor for executing the control program stored in the memory,
wherein the processor receives a video, detects an event in the video using a learning model that is trained with resource images used for event detection, and extracts at least one highlight video based on the event.

11. The apparatus of claim 10, wherein the processor preprocesses the received video.

12. The apparatus of claim 11, wherein the processor divides the received video into frames, thereby preprocessing the received video.

13. The apparatus of claim 10, wherein the processor analyzes whether the detected event is a single event or a complex event including multiple events.

14. The apparatus of claim 10, wherein the processor sets a highlight section based on a point at which the event occurs and generates the highlight video using a video of the highlight section.

15. The apparatus of claim 14, wherein the processor sets a point from which a highlight starts by analyzing a preceding part of the video based on the point at which the event occurs and sets the point at which the event occurs as a point at which the highlight ends, thereby setting the highlight section.

16. The apparatus of claim 10, wherein, when the highlight video comprises multiple highlight videos, the processor selects the highlight video to be provided to a user from among the multiple highlight videos based on a preference of the user and provides the selected highlight video.

17. The apparatus of claim 10, wherein the event includes at least one of a kill event between characters in the video, a death event therebetween, an assistance event therebetween, or a main object destruction event in the video, or a combination thereof.

18. The apparatus of claim 10, wherein the video includes a real-time video or a previously stored video.
